(19) United States
(12) Patent Application Publication
(10) Pub. No.: US 2014/0115530 A1
(43) Pub. Date: Apr. 24, 2014

(54) Page Processing at Touch Screen Display

(71) Applicant: Alibaba Group Holding Limited, Grand Cayman (KY)

(72) Inventor: Qiqi Wang, Hangzhou (CN)

(73) Assignee: Alibaba Group Holding Limited, Grand Cayman (KY)

(21) Appl. No.: 14/057,725

(22) Filed: Oct. 18, 2013

(30) Foreign Application Priority Data
Oct. 19, 2012 (CN) 201210401741.1

(51) Int. Cl. G06F 3/01

(52) U.S. Cl. CPC G06F 3/017
USPC 715/788

(57) ABSTRACT

The present disclosure provides example methods, apparatuses, and devices of processing a page at a touch screen display. The page is divided into multiple page sections. The multiple page sections are loaded and presented by multiple page containers. When the page is displayed, the present techniques detect a gesture that triggers a page processing. When the gesture is detected, the page processing is applied to a gesture affected area, including enlarging or reducing a size of a page container in the gesture affected area. The present techniques may help the user conveniently operate the page and accurately view the user's desired contents by detecting the gesture of the user.

### CROSS REFERENCE TO RELATED PATENT APPLICATIONS

This application claims foreign priority to Chinese Patent Application No. 201210401741.1 filed on 19 Oct. 2012, entitled “Method, Apparatus, and Electronic Device for Page Processing at Touch Screen Display,” which is hereby incorporated by reference in its entirety.

### TECHNICAL FIELD

The present disclosure relates to the field of page processing, and more specifically, to a method, an apparatus, and an electronic device for page processing at a touch screen display.

### BACKGROUND

Cell phones often use a long page or list to display contents. When a user views the long page, such as a novel, a long list, etc., at a cell phone, the user often desires to skip some contents at the top of the page to read other contents. For example, the user may desire to quickly skip the page to view recent chapters of the novel. For another example, the user may want to skip some items in a shopping list of a shopping application to view other items in the shopping list. However, the user may need to slide the page for a long time to locate his/her desired contents.

The conventional techniques are based on designs for personal computers (PCs) and neglect differences between the PCs and the cell phones and unique characteristics of the cell phones. For example, the conventional techniques may use side slides similar to those of a PC to quickly view the page.

However, there are several pitfalls. The cell phones' screens are pretty small. Thus, it is difficult for the user to roll the slides and locate contents. The user also easily skips his/her expected contents. In addition, some side slides are represented in a form of relatively large squares for finger operations of the user. The user may thus incidentally touch the side slides to cause wrong operations. Furthermore, the existence of the side slides may influence content viewing.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to apparatus(s), system(s), method(s) and/or computer-readable instructions as permitted by the context above and throughout the present disclosure.

The present disclosure provides a method, an apparatus, and an electronic device for page processing at a touch screen display.

The present disclosure provides an example method for page processing at a touch screen display. A page is divided into multiple page sections. The multiple page sections are loaded and presented by multiple page containers. When the page is displayed, the present techniques detect a gesture that triggers a page processing. When the gesture is detected, the page processing is applied to a gesture affected area, including enlarging or reducing a size of a page container in the gesture affected area.

The present disclosure provides an example apparatus for page processing at a touch screen display. Such an apparatus may be used at an electronic device that has the touch screen display. The apparatus may include a page dividing module, a gesture detecting module, and a page processing module.

The page dividing module divides a page into multiple page sections. The multiple page sections are loaded and presented by multiple page containers. The gesture detecting module, when the page is displayed, detects a gesture that triggers a page processing. The page processing module, when the gesture is detected, applies the page processing to a gesture affected area, including enlarging or reducing a size of a page container in the gesture affected area.

The present disclosure also provides an example electronic device. The electronic device may include a touch screen display. The electronic device may also include the example apparatus for page processing at the touch screen display.

The present disclosure also provides another example electronic device, which includes a touch screen display, one or more computer storage media, and one or more processors. The computer storage media store computer-executable instructions. The processors are coupled with the computer storage media and configured to execute the computer-executable instructions stored on the computer storage media. The computer-executable instructions stored on the computer storage media and the processors are configured to perform the methods for page processing at the touch screen display.

The present techniques divide the page into multiple page sections presented by multiple page containers. When the gesture is detected, the present techniques implement a page operation through a processing of the page container so that the user may accurately view his/her desired contents. Particularly, the user may use a pinch gesture or an expansion gesture to imitate folding or wrinkling in real life to fold contents for quick viewing. Thus, the user may quickly view the desired contents. Such smooth viewing method, when applied to a long page, achieves a convenient and natural effect that resolves many pitfalls of the conventional side slides. In addition, an extent of the pinch or expansion gesture may control an extent of folded contents. Thus, the present techniques are convenient and natural, prone to real life, and more suitable for cell phone operations. The present techniques are easier to understand and implement.

For example, the present techniques are suitable for electronic devices with small displays such as the cell phones, do not occupy space at the displays, and may prevent incorrect operations.

### BRIEF DESCRIPTION OF THE DRAWINGS

To better illustrate the embodiments of the present disclosure, the following is a brief introduction of the FIGs to be used in the description of the embodiments. It is apparent that the following FIGs only relate to some embodiments of the present disclosure. A person of ordinary skill in the art can obtain other FIGs according to the FIGs in the present disclosure without creative efforts. The example embodiments and their specifications are used to illustrate the present disclosure and shall not constitute inappropriate restrictions to the present disclosure.

FIG. 1 illustrates a flowchart of an example method for page processing at a touch screen display according to a first example embodiment of the present disclosure.

FIG. 2 illustrates an example folding or wrinkling effect, in which the folding or wrinkling has a regular polyline shape.

FIG. 3 illustrates another example folding or wrinkling effect, in which the folding or wrinkling has a regular wave shape.

FIG. 4 illustrates a flowchart of another example method for page processing at the touch screen display according to a second example embodiment of the present disclosure.

FIG. 5 illustrates a diagram of an example page area that has a folding or wrinkling effect.

FIG. 6 illustrates s a diagram of another example page area that has the folding or wrinkling effect.

FIG. 7 is a flowchart of an example method for determining whether the gesture affected area of a pinch gesture or an expansion gesture reaches a limit of application of the pinch gesture or the expansion gesture.

FIG. 8 illustrates a flowchart of an example process for responding to the pinch gesture or the expansion gesture when the page contents of the gesture affected area are at a non-folding expansion status.

FIG. 9 shows a diagram of an example operation of rotating the page from the x-axis or y-axis.

FIG. 10 shows a diagram of an example change of an odd section of the page contents.

FIG. 11 shows a diagram of an example change of an even section of the page contents.

FIG. 12 shows an example change of the page contents responding to the pinch gesture or the expansion gesture when a shopping list is displayed at the touch screen display.

FIG. 13 shows another example change of the page contents responding to the pinch gesture or the expansion gesture when the shopping list is displayed at the touch screen display.

FIG. 14 illustrates an example apparatus for page processing at the touch screen display.

### DETAILED DESCRIPTION

The present techniques are described in detail below by reference to the FIGS and example embodiments. It is noted that unless there is a conflict, the example embodiments or features of the example embodiments may be referenced to each other or combined.

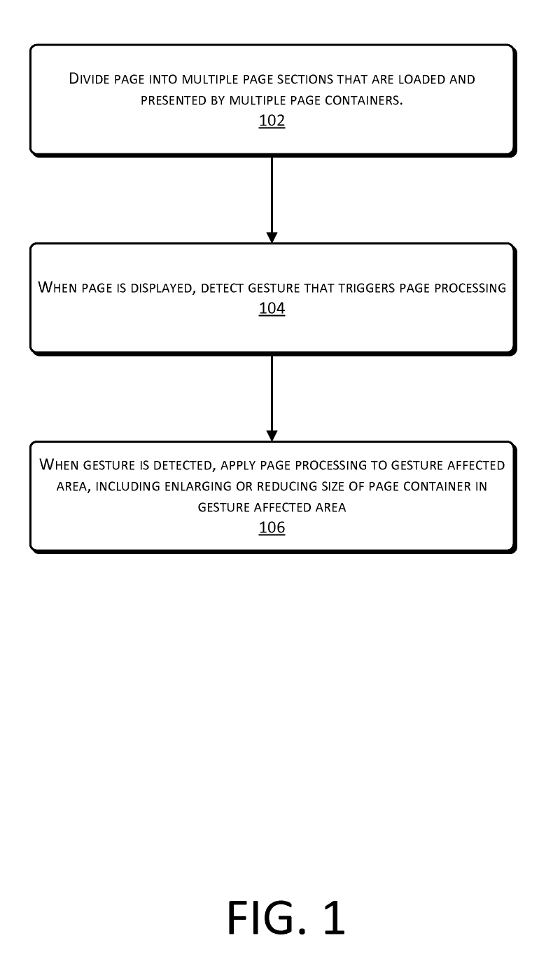

FIG. 1 illustrates a flowchart of an example method for page processing at a touch screen display according to a first example embodiment of the present disclosure. The example method may be applied in an electronic device with the touch screen display.

At 102, a page is divided into multiple page sections. The multiple page sections are loaded and presented by multiple page containers. The present techniques may be suitable for pages of any application programs. The application programs may include, but are not limited to including, an e-mail application, a blog application, a browser application, a shopping application (such as Taobao™), or a reading application. The electronic device may have the touch screen display that captures gestures, including but not limited to a cell phone, a tablet, etc.

At 104, when the page is displayed, the present techniques detect a gesture that triggers a page processing. The gesture may include, but is not limited to including, a click, a change of an effective distance between points, or a specific moving track along the points (such as a line or a circle) at the touch screen display.

A gesture that gradually increases the effective distance between the points is referred to as an expansion gesture. A gesture that gradually decreases the effective distance between the points is referred to as a pinch gesture. The expansion gesture and the pinch gesture may be a two-point or multi-point gesture, which may be implemented through either a pen touch or a finger touch according to different usage behaviors.

At 106, when the gesture is detected, the page processing is applied to a gesture affected area, which may include enlarging or reducing a size of a page container in the gesture affected area.

For example, the size of the page container may be enlarged or reduced within a permitted limit size. The gesture affected area may be determined according to a preset algorithm.

Using the expansion gesture or the pinch gesture as an example, the points of the pinch gesture or the expansion gesture may be used to determine the gesture affected area of the pinch gesture or the expansion gesture of current page contents. For instance, the page contents between positions of starting points of the pinch gesture or the expansion gesture may be the gesture affected area of the pinch gesture or the expansion gesture.

For another example, the current page may be divided into multiple sections. A starting position of a touch of the pinch gesture or the expansion gesture is used to determine a section corresponding to the touch and a border of the section corresponding to the touch is used to determine the gesture affected area. For instance, in an up-and-bottom folding mode, an up border of an up point of the pinch gesture of the expansion gesture is used as an up border of the gesture affected area while a bottom border of a bottom point of the pinch gesture of the expansion gesture is used as a bottom border of the gesture affected area. Alternatively, an up border of a section corresponding to the two or multiple points of the gesture may be used to determine the gesture affected area.

When a gesture that gradually reduces the effective distance between points is detected, a size of one or more page containers in the gesture affected area is reduced along a direction that the effective distance between the points is reduced. When a gesture that gradually increases the effective distance between points is detected, a size of one or more page containers in the gesture affected area is increased along a direction that the effective distance between the points is increased. The gesture affected area may include one page container or multiple adjacent page containers.

The higher a changed value of the effective distance between the points is, the higher a proportion of reducing or enlarging of the page container in the gesture affected area is. The effective distance may refer to a distance along a reducing or enlarging direction.

The page processing may also include changing a size, a display position, a color of the page container and/or aggregating multiple page containers. For example, the page processing may cause a folding or wrinkling effect at the gesture affected area of the page upon the user's needs.

For another example, the page processing may cause a dynamic effect at the page according to a change of the gesture or display a final result after the gesture completes.

Page data for the page processing may include page content data and page container data. Alternatively, the pate data may include only the page container data. The page container data adjusts a shape, a size, a color, and/or a display location of the page container to cause a corresponding page section to appear the folding or wrinkling effect.

For example, if the current page is viewed in the up and down mode, the multiple adjacent containers may be placed or processed such that one page container with a shape of an inverted trapezoid that is wider at top and narrower at bottom alternates another page container with a shape of a trapezoid that is narrower at top and wider at bottom. Alternatively, if the current page is viewed in the up and down mode, the multiple adjacent containers may be placed or processed such that one page container with a shape of parallelogram that is slanted toward left alternates another page container with a shape of a parallelogram that is slanted toward right.

For another example, if the current page is viewed in the left and right mode, the multiple adjacent containers may be placed or processed such that one page container with a shape of an inverted trapezoid that is wider at left and narrower at right alternates another page container with a shape of a trapezoid that is narrower at left and wider at right. Alternatively, if the current page is viewed in the left and right mode, the multiple adjacent containers may be placed or processed such that one page container with a shape of parallelogram that is slanted to the top alternates another page container with a shape of a parallelogram that is slanted to the bottom.

The present techniques respond to the detected pinch or expansion gesture within an area limit. The present techniques process page contents with the gesture affected area of the pinch gesture or the expansion gesture. If the present techniques detect the pinch gesture, the processing generates or increases the folding or wrinkling effect of the gesture affected area of the pinch gesture and a display area of the page content in the gesture affected area is reduced. If the present techniques detect the expansion gesture, the processing reduces or eliminates the folding or wrinkling effect of the gesture affected area of the expansion gesture and a display area of the page content in the gesture affected area is enlarged.

For example, the area limit may refer to a range from a smallest display area to a largest display area for the page contents or page section.

For example, based upon configuration and requirements, different folding or wrinkling modes may be used to generate different folding or wrinkling effects. A specific folding or wrinkling mode may be determined by a directional effect, a size effect, and a visual effect of the folding or wrinkling. The directional effect of the folding or wrinkling may include a left-right folding or wrinkling, a top-bottom folding or wrinkling, a diagonal folding or wrinkling, or from-surroundings-to-center folding or wrinkling.

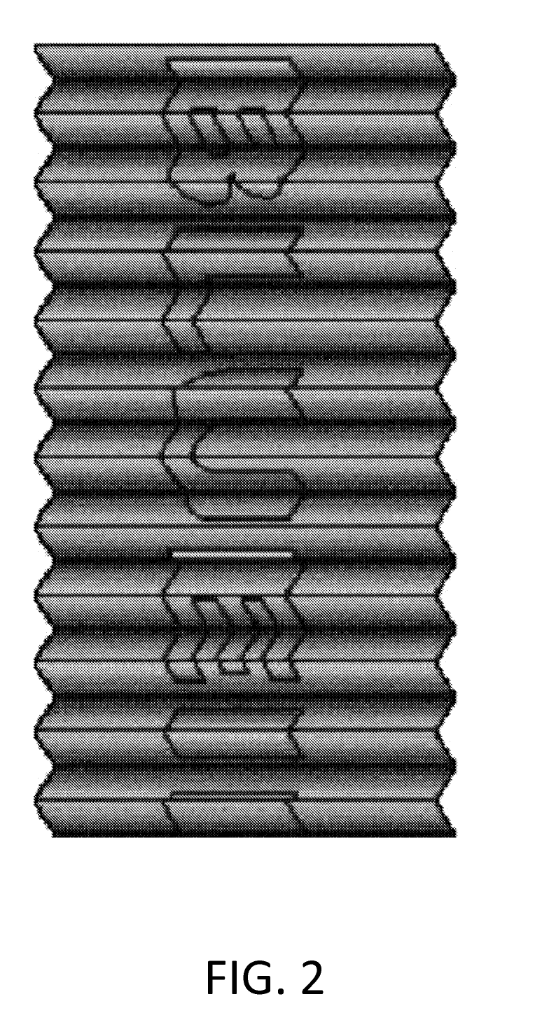

FIG. 2 shows an example folding or wrinkling effect, in which the folding or wrinkling has a regular polyline shape. For another example, the folding or wrinkling may have an irregular polyline shape.

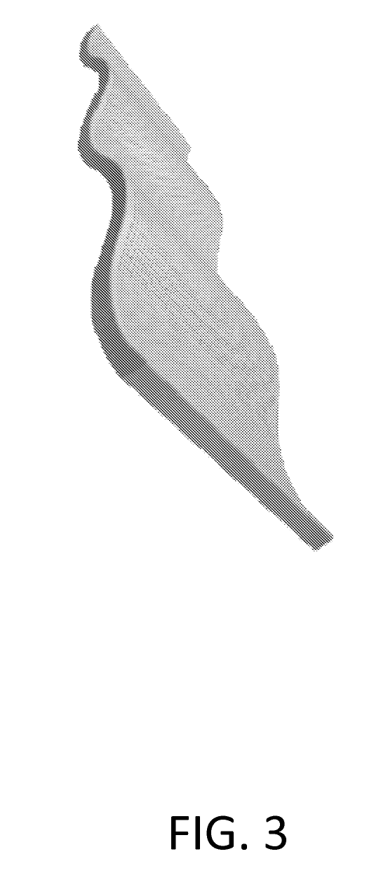

FIG. 3 shows another example folding or wrinkling effect, in which the folding or wrinkling has a regular wave shape. For another example, the folding or wrinkling may have an irregular wave shape.

For example, the folding or wrinkling effect may have a two-dimension visual effect or a three-dimension visual effect.

For example, the effective distance may refer to a distance along the reducing or enlarging direction. For instance, if the present techniques implement the left and right folding or wrinkling, a distance at a left and right direction is the effective distance. For another instance, if the present techniques implement the diagonal folding or wrinkling, a distance at a diagonal direction is the effective distance.

A changed value of the effective distance determines a proportion of the reduction and enlargement. That is, the larger the changed value of the effective distance within a threshold is, the larger the proportion of reducing or enlarging the page container is.

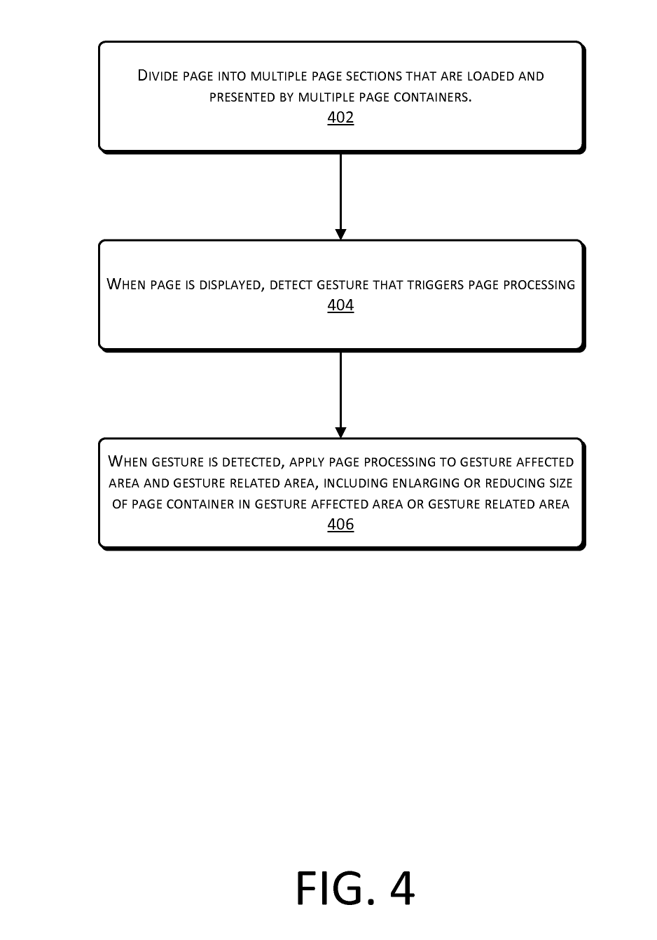

A second example embodiment of the present disclosure may be applied in the electronic device with the touch screen display. FIG. 4 illustrates a flowchart of another example method for page processing at the touch screen display according to a second example embodiment of the present disclosure.

At 402, a page is divided into multiple page sections. The multiple page sections are loaded and presented by multiple page containers.

At 404, when the page is displayed, the present techniques detect a gesture that triggers a page processing.

At 406, when the gesture is detected, the page processing is applied to a gesture affected area or a gesture adversely affected area, which may include enlarging or reducing a size of a page container in the gesture affected area or the gesture adversely affected area.

The gesture affected area or the gesture adversely affected area may be determined by a preset algorithm.

When a gesture that gradually reduces the effective distance between points is detected, a size of one or more page containers in the gesture adversely affected area is increased along a direction that the effective distance between the points is reduced. When a gesture that gradually increases the effective distance between the points is detected, a size of one or more page containers in the gesture adversely affected area is reduced along a direction that the effective distance between the points is increased. The gesture adversely affected area may include one page container or multiple adjacent page containers.

The higher a changed value of the effective distance between the points is, the higher a proportion of reducing or enlarging of the page container in the gesture affected area or the gesture adversely affected area is. The effective distance may refer to a distance along a reducing or enlarging direction.

Based on specific configuration and needs, the page data for the page processing may include page content data and page container data. The page container data adjusts a shape, a size, a color, and/or a display location of the page container to cause a two-dimensional, three-dimensional, regular or irregular folding or wrinkling effect at a corresponding page section. The page content data is also processed accordingly to be adjustable to the displayed page container.

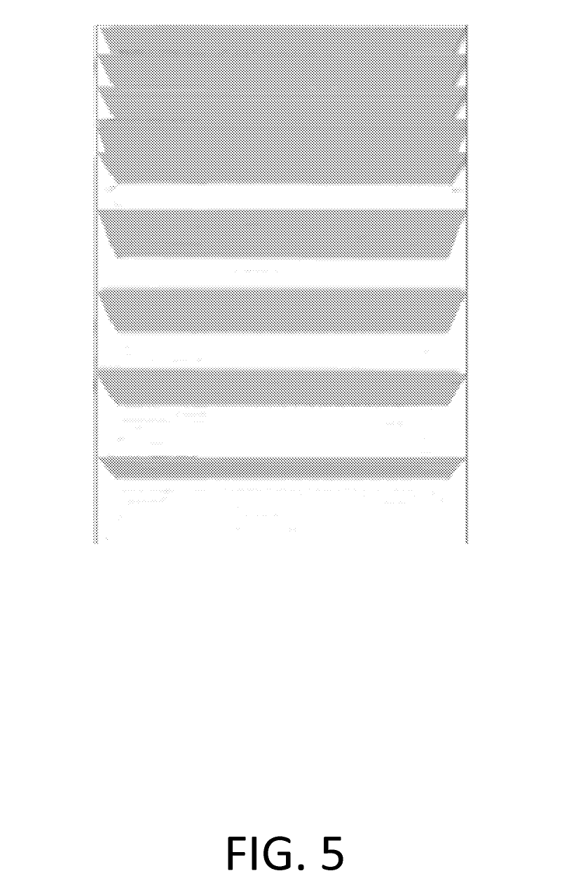

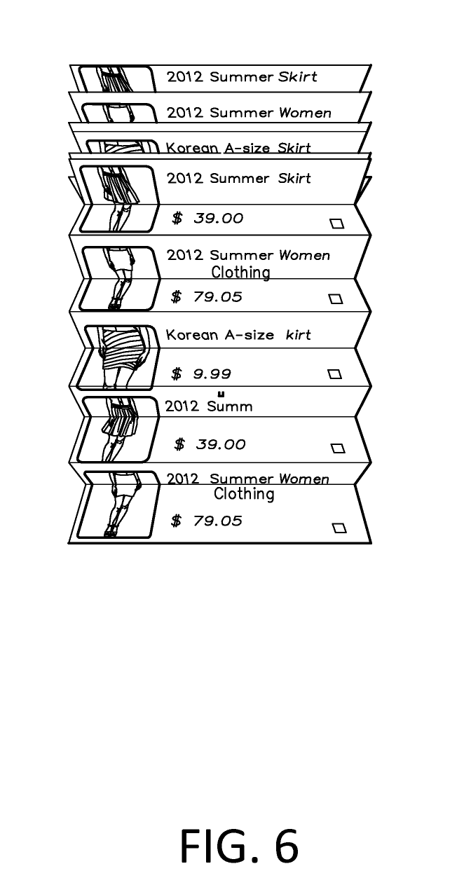

Alternatively, in a simplified scenario, the pate data may include only the page container data. Under this scenario, the page section that is reduced relative to a normal display may only display the page container. The folding or reducing effect of the page container within a display hides the corresponding page contents. FIG. 5 shows a diagram of an example page area that has the folding or wrinkling effect, in which the corresponding page contents are hidden. Alternatively, when the page section is reduced to a preset threshold, the corresponding page content is hid and only the page container is presented. When the page section is enlarged to another preset threshold, the corresponding page content and the page container are presented. FIG. 6 shows a diagram of another example page area that has the folding or wrinkling effect, in which the page container is presented and corresponding page contents are hid when the page section is reduced to a preset threshold while both the page container and the corresponding page contents are presented when the page section is enlarged to another preset threshold.

For another example, the original page data of a page area or section prior to the page processing may be saved and backed up. A copy of the page data is processed as image data such as bitmap data (which only has an image effect but does not have a hyperlink, i.e., special page content data after the processing). The bitmap data is deformed and aggregated with the page container data. When the folding or wrinkling effect disappears, the original page data of the page area is presented.

In an example implementation, when the page contents are displayed in the up and down mode, the page container data may have the following characteristics. The page contents displayed at the touch screen display may be placed such that an inverted trapezoid that is wider at top and narrower at bottom alternates a trapezoid that is narrower at top and wider at bottom to appear a regular three-dimensional folding effect. Alternatively, the page contents displayed at the touch screen display may be placed such that a parallelogram that is slanted toward left alternates a parallelogram that is slanted toward right to appear a regular three-dimensional folding effect.

In another example implementation, when the page contents are displayed in the left and right mode, the page container data may have the following characteristics. The page contents displayed at the touch screen display may be placed such that an inverted trapezoid that is wider at left and narrower at right alternates a trapezoid that is narrower at left and wider at right to appear the regular three-dimensional folding effect. Alternatively, the page contents displayed at the touch screen display may be placed such that a parallelogram that is slanted to top alternates a parallelogram that is slanted to bottom to appear the regular three-dimensional folding effect.

The above folding effects have a polygonal line shape. The present techniques may also implement the folding effects that have a wave shape.

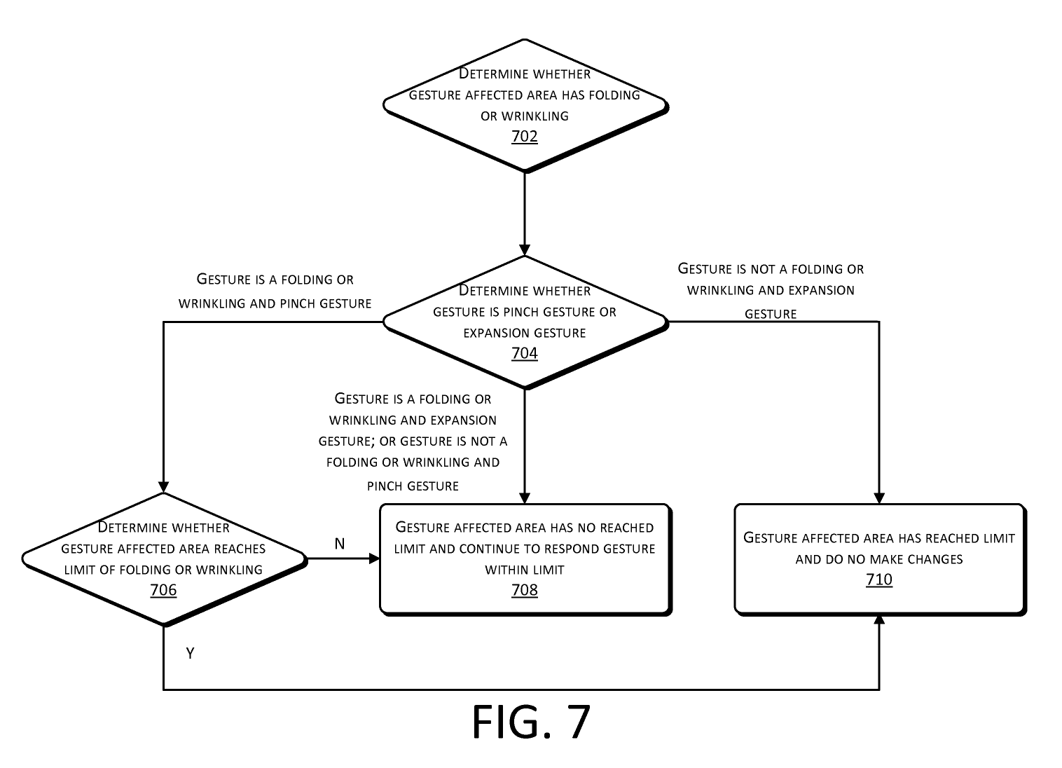

In the present disclosure, generating or increasing the folding effect may be referred to as a reduction. Reducing or eliminating the folding effect may be referred to as an expansion. FIG. 7 is a flowchart of an example method for determining whether the gesture affected area of the pinch gesture or the expansion gesture reaches a limit of application of the pinch gesture or the expansion gesture.

At 702, the present techniques determine whether there is a folding or wrinkling at the gesture affected area.

At 704, the present techniques determine whether the gesture is the pinch gesture or the expansion gesture. If the gesture affected area is determined to have folding or wrinkling and the gesture is determined to be the expansion gesture, operations at 706 are performed. If the gesture affected area is determined to have folding or wrinkling and the gesture is determined to be the expansion gesture, or if the gesture affected area is determined not to have folding or wrinkling and the gesture is determined to be the pinch gesture, operations at 708 are performed. If the gesture affected area is determined not to have folding or wrinkling and the gesture is determined to be the expansion gesture, operations at 710 are performed.

At 706, it is determined whether the gesture affected area reaches a limit of the folding or wrinkling effect. If a determining result is positive, operations at 710 are performed. If the determining result is negative, operations at 708 are performed.

At 708, it is determined that the gesture affected area has not reached the limit of the folding or wrinkling effect and the present techniques continue to respond to the pinch gesture or the expansion gesture within an area threshold.

At 710, it is determined that the gesture affected area has reached the limit of the folding or wrinkling effect and the present techniques do not make changes or do not respond to the gesture.

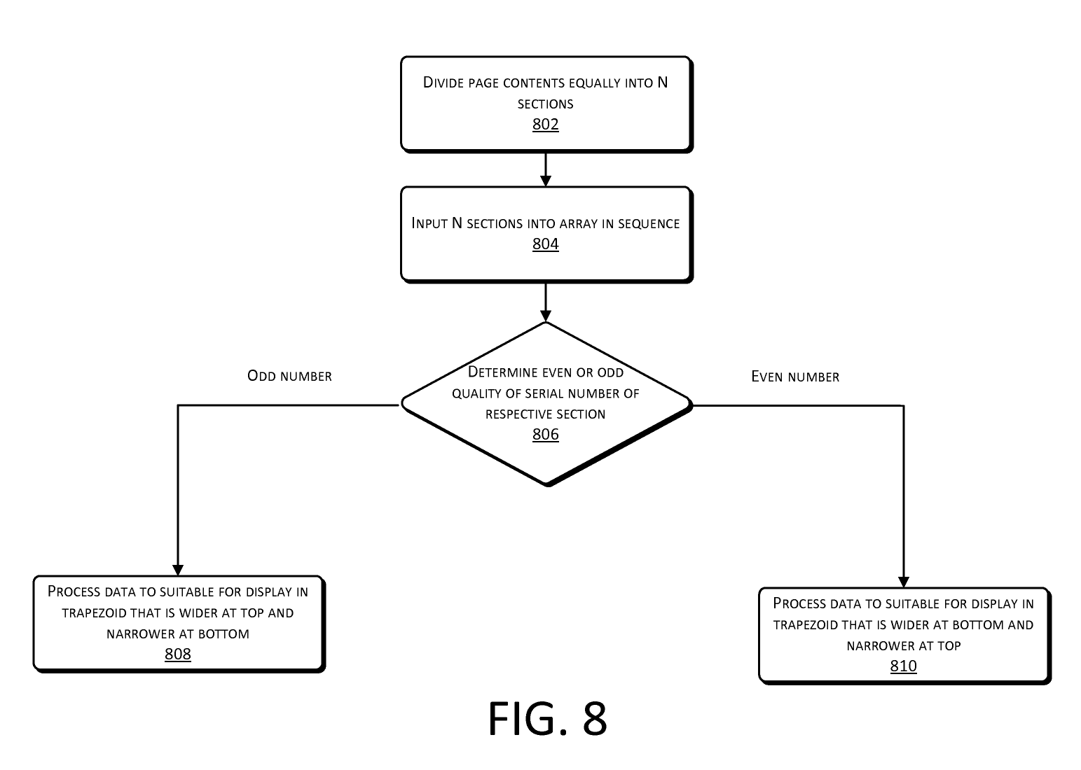

Using an example of three-dimensional folding effect, FIG. 8 illustrates a flowchart of an example process for responding to the pinch gesture or the expansion gesture when the page contents of the gesture affected area are at a non-folding expansion status and the gesture is the pinch gesture.

At 802, the page contents are divided into N sections. N may be any positive integer. For instance, the page contents may be equally divided.

At 804, the N sections are input into an array in a sequence.

At 806, an even or odd quality of a serial number of each section in the array is determined. If a serial number of a respective section is odd, operations at 808 are performed. Otherwise, operations at 810 are performed.

At 808, a section whose serial number is odd is processed to data suitable for display in the trapezoid that is wider at the top and narrower at the bottom.

At 810, a section whose serial number is even is processed to data suitable for display in the trapezoid that is wider at the bottom and narrower at the top.

A combination of the section whose serial number is odd and the section whose serial number is even presents the three-dimensional folding effect.

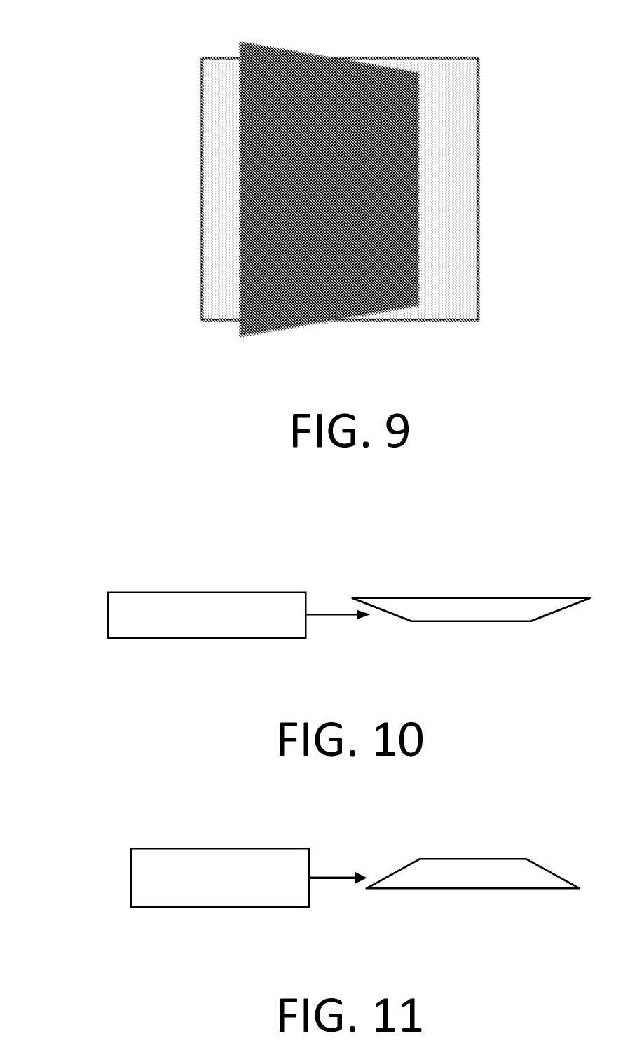

The above process may be implemented through computer-executable instructions or codes as follows. Firstly, the page may be rotated horizontally or vertically or from a perspective of x-axis or y-axis to imitate the three-dimensional effect. FIG. 9 shows a diagram of an example operation of rotating the page from the x-axis or y-axis.

Secondly, the page contents are divided according to their HyperText Markup Language (HTML) codes. For instance, the page contents may be divided into four sections. The odd or even sections are changed respectively to obtain the folding effect. FIG. 10 shows a diagram of an example change of an odd section. FIG. 11 shows a diagram of an example change of an even section.

Thirdly, it is determined whether to shrink or expand the sections. For instance, JavaScript codes may be used for the determination.

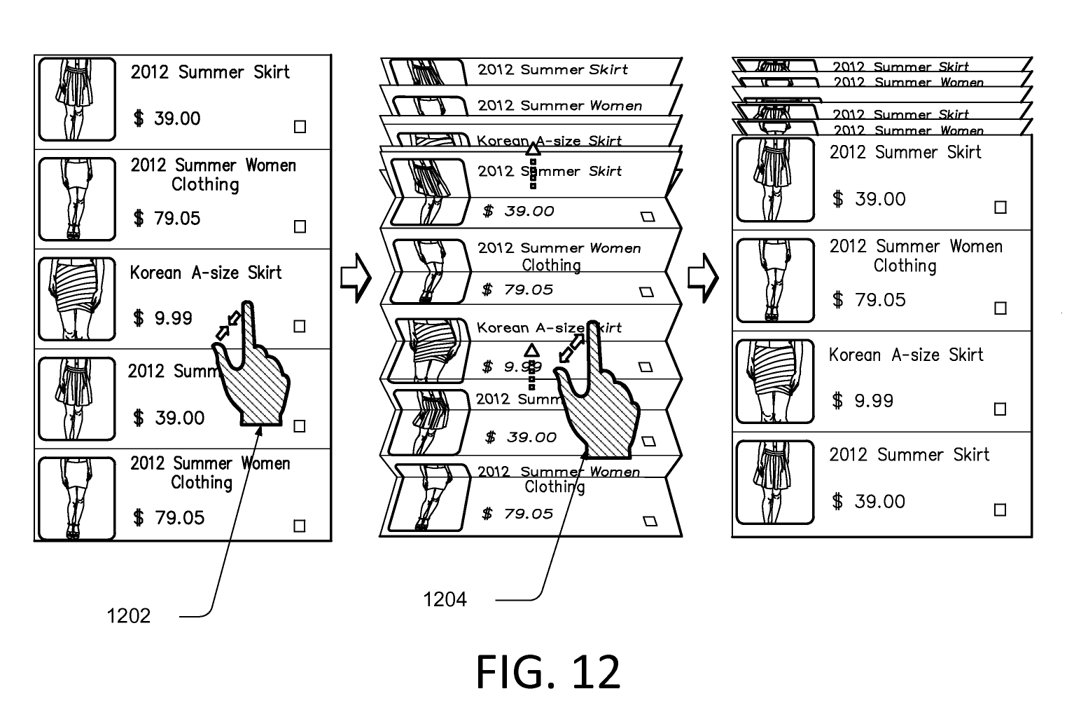

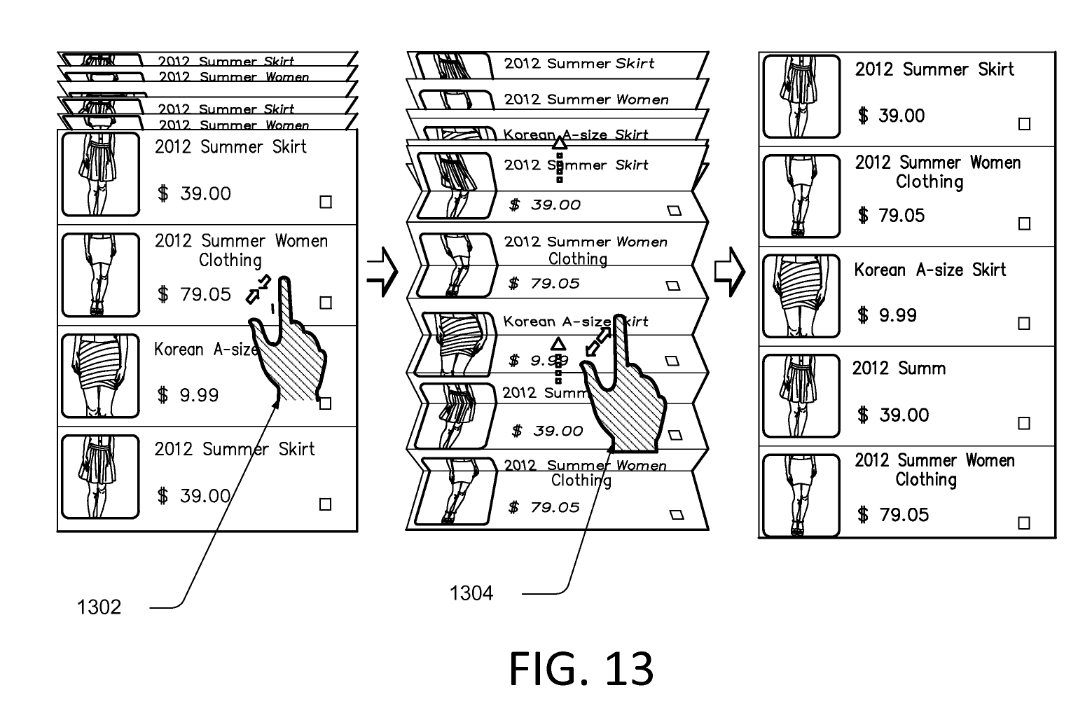

FIG. 12 and FIG. 13 each shows a diagram of an example process of responding to the pinch gesture or the expansion gesture when a shopping list is displayed at the display screen. The shopping list may be a shopping list from Taobao™, an e-commerce website. The present techniques may respond to a pinch gesture 1202 or 1302 to fold a currently viewed content up and pull contents below the current viewed content up. Thus, the user may quickly view contents previously located at an N-th screen at a current screen, where N may be any integer. The larger the extent of the pinch gesture is, the more contents are folded and the more contented are pulled up. Such operations may be repeated. The contents below the currently view content may be continuously folded and push the previously folded content out of the display screen. Such operations may be continued until the user finds his/her desired contents.

If the user would like to view the previous contents, the user may use an expansion gesture 1204 or 1304 at the folded sections or the pinch gesture 1202 or 1302 at the expanded sections. The present techniques would respond and pull down contents above the currently viewed contents or folded down the contents below the currently viewed contents. For example, the present techniques may correspond to the extent of the gesture to control the extent of pulled or folded contents.

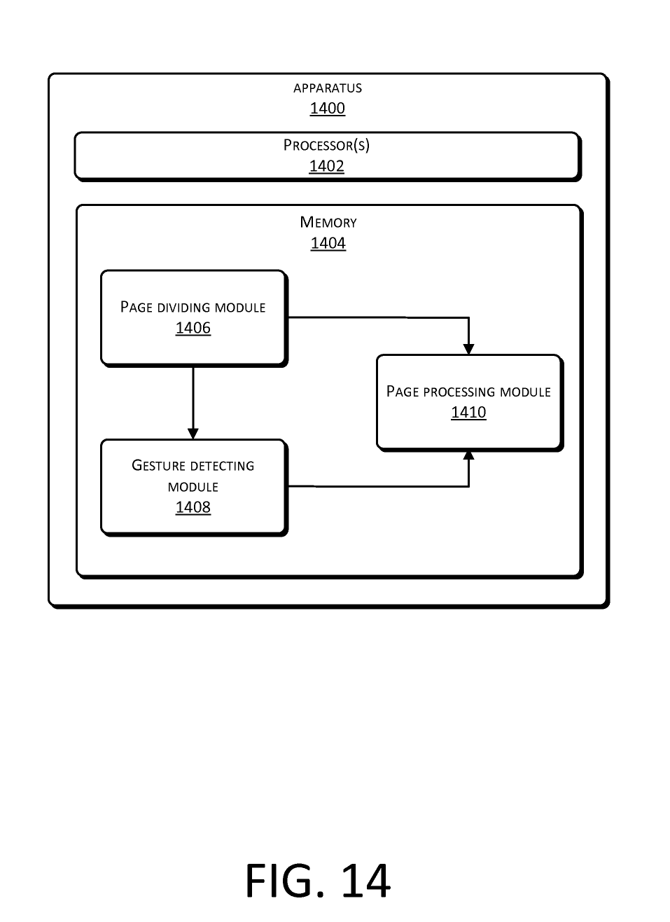

To implement the above examples methods for page processing at the touch screen display, the present disclosure also provides an example apparatus for page processing at the touch screen display. Such apparatus may be used in an electronic device that is equipped with the touch screen display. FIG. 14 illustrates an example apparatus 1400 for page processing at the touch screen display.

The apparatus 1400 may include one or more processor(s) 1402 and memory 1404. The memory 1404 is an example of computer-readable media. As used herein, “computer-readable media” includes computer storage media and communication media.

Computer storage media includes volatile and non-volatile, removable and non-removable media implemented in any method or technology for storage of information such as computer-executed instructions, data structures, program modules, or other data. In contrast, communication media may embody computer-readable instructions, data structures, program modules, or other data in a modulated data signal, such as a carrier wave. As defined herein, computer storage media does not include communication media. The memory 404 may store therein program units or modules and program data.

In the example of FIG. 14, the memory 1404 may store therein a page dividing module 1406, a gesture detecting module 1408, and a page processing module 1410. The page dividing module 1406 divides a page into multiple page sections. The multiple page sections are loaded and presented by multiple page containers. The gesture detecting module 1408, when the page is displayed, detects a gesture that triggers a page processing. The page processing module 1410, when the gesture is detected, applies the page processing to a gesture affected area, including enlarging or reducing a size of a page container in the gesture affected area. The page processing module 1410 may implement the example methods for page processing as described in the first example embodiment.

The gesture may include, but is not limited to including, a click, a change of an effective distance between points, or a specific track of a moving along points (such as a line or a circle).

A gesture that gradually increases the effective distance between the points is referred to as the expansion gesture. A gesture that gradually decreases the effective distance between the points is referred to as the pinch gesture.

For example, when a gesture that gradually reduces the effective distance between the points is detected, the page processing module 1410 reduces a size of one or more page containers in the gesture affected area along a direction that the effective distance between the points is reduced. When a gesture that gradually increases the effective distance between the points is detected, the page processing module 1410 increases a size of one or more page containers in the gesture affected area along a direction that the effective distance between the points is increased. The gesture affected area may include one page container or multiple adjacent page containers.

Corresponding to the second example method embodiment, when the gesture is detected, the page processing module 1410 also applies the page processing to the gesture adversely affected area. When a gesture that gradually reduces the effective distance between the points is detected, the page processing module 1410 increases a size of one or more page containers in the gesture adversely affected area along a direction that the effective distance between the points is reduced. When a gesture that gradually increases the effective distance between the points is detected, the page processing module 1410 reduces a size of one or more page containers in the gesture adversely affected area along a direction that the effective distance between the points is increased. The gesture adversely affected area may include one page container or multiple adjacent page containers.

For example, the higher a changed value of the effective distance between the points is, the higher a portion of reducing or enlarging of the page container in the gesture affected area or the gesture adversely affected area is. The effective distance may refer to a distance along a reducing or enlarging direction.

For example, the page processing may include changing a shape, a display location, a color of a respective page container, and/or aggregating multiple page containers. The page processing may cause the page sections to have the folding or wrinkling effect.

For another example, the page processing may also cause the page to have the dynamic effect upon a change of the gesture or display a final result after the gesture completes.

For instance, if the current page is viewed in the up and down mode, the multiple adjacent page containers may be placed such that one page container with a shape of an inverted trapezoid that is wider at top and narrower at bottom alternates another page container with shape of a trapezoid that is narrower at top and wider at bottom. Alternatively, if the current page is viewed in the up and down mode, the multiple adjacent page containers may be placed such that one page container with a shape of a parallelogram that is slanted toward left alternates another page container with a shape of a parallelogram that is slanted to a right.

For another example, if the current page is viewed in the left and right mode, the multiple adjacent page containers may be placed such that one page container with a shape of an inverted trapezoid that is wider at left and narrower at right alternates another page container with a shape of a trapezoid that is narrower at left and wider at right. Alternatively, if the current page is viewed in the left and right mode, the multiple adjacent page containers may be placed such that one page container with a shape of a parallelogram that is slanted to top alternates another page container with a shape of a parallelogram that is slanted to bottom.

If the gesture is detected to be the pinch gesture, the page processing module 1410 may process the page to generate or increase the folding or wrinkling effect at the gesture affected area of the pinch gesture and reduce the display area. If the gesture is detected to be the expansion gesture, the page processing module 1410 may process the page to reduce or eliminate the folding or wrinkling effect at the gesture affected area of the pinch gesture and increase the display area.

For example, the folding or wrinkling effect may include a directional effect, a size effect, and a visual effect of the folding or wrinkling.

In addition to the apparatus for page processing at the touch screen display, the present disclosure also provides an example electronic device that includes the touch screen display and the apparatus for page processing at the touch screen display.

For example, the electronic device may include the touch screen display, one or more computer storage media, and one or more processors.

The computer storage media store computer-executable instructions. The processors are coupled with the computer storage media and configured to execute the computer-executable instructions stored on the computer storage media. The computer-executable instructions stored on the computer storage media and the processors are configured to perform any example method for page processing at the touch screen display or their variations.

The present techniques divide the page into multiple page sections presented by multiple page containers. When the gesture is detected, the present techniques implement a page operation through a processing of the page container so that the user may accurately view his/her desired contents. Particularly, the user may use a pinch gesture or an expansion gesture to imitate folding or wrinkling in real life to fold contents that require quick viewing. Thus, the user may more quickly view the desired contents. Such smooth viewing method, when applied to viewing a long page, achieves a convenient and natural effect that resolves many pitfalls of the conventional side slides. In addition, an extent of the pinch or expansion gesture may control an extent of folded contents. Thus, the present techniques are convenient and natural, prone to real life, and more suitable for cell phone operations. The present techniques are easier to understand and implement.

For example, the present techniques may be suitable for electronic devices with small displays such as the cell phones, not occupy much space at the displays, and prevent incorrect operations.

What is claimed is:

1. A method for processing a page at a touch screen display, the method comprising:
dividing the page into multiple page sections, each page section including one or more page containers;
detecting a gesture that triggers a page processing; and
applying the page processing to a gesture affected area of the gesture, the gesture affected area including one or more page sections, the page processing including enlarging or reducing a size of a page container in the gesture affected area.

2. The method as recited in claim 1, wherein the gesture includes a click, a change of an effective distance between points, or a specific moving track along the points at the touch screen display.

3. The method as recited in claim 1, wherein:
the gesture is an expansion gesture that increases an effective distance between points at the touch screen display, the effective distance being a distance between the points along an enlarging direction; and
the page processing comprises enlarging the size of the page container along the enlarging direction in the gesture affected area.

4. The method as recited in claim 3, wherein the enlarging comprises enlarging the size of the page container in the gesture affected area proportional to a changed value of the effective distance.

5. The method as recited in claim 1, wherein:
the gesture is a pinch gesture that decreases an effective distance between points at the touch screen display, the effective distance being a distance between the points along a reducing direction; and
the page processing comprises reducing the size of the page container along the reducing direction in the gesture affected area.

6. The method as recited in claim 5, wherein the reducing comprises reducing the size of the page container in the gesture affected area proportional to a changed value of the effective distance.

7. The method as recited in claim 1, wherein:
the gesture is an expansion gesture that increases an effective distance between points at the touch screen display, the effective distance being a distance between the points along an enlarging direction; and
the page processing comprises reducing a size of a page container along the enlarging direction in a gesture adversely affected area.

8. The method as recited in claim 1, wherein:
the gesture is a pinch gesture that decreases an effective distance between points at the touch screen display, the effective distance being a distance between the points along a reducing direction; and
the page processing comprises enlarging a size of a page container along the reducing direction in a gesture adversely affected area.

9. The method as recited in claim 1, wherein the page processing further includes changing a size, a display position, a color of the page container, or aggregating multiple page containers.

10. The method as recited in claim 1, further comprising:
when the page is displayed in an up and down mode, processing a first page container with a shape of an inverted trapezoid that is wider at a top and narrower at a bottom;
processing a second page container with a shape of a trapezoid that is narrower at a top and wider at a bottom; and
placing the first page container with the second page container alternatively to present page contents.

11. The method as recited in claim 1, further comprising:
when the page is displayed in an up and down mode, processing a first page container with a shape of a parallelogram that is slanted toward left;
processing a second page container with a shape of a parallelogram that is slanted toward right; and
placing the first page container with the second page container alternatively to present page contents.

12. The method as recited in claim 1, further comprising:
when the page is displayed in a left and right mode, processing a first page container with a shape of an inverted trapezoid that is wider at a left and narrower at a right;
processing a second page container with a shape of a trapezoid that is narrower at a left and wider at a right; and
placing the first page container with the second page container alternatively to present page contents.

13. The method as recited in claim 1, further comprising:
when the page is displayed in a left and right mode, processing a first page container with a shape of a parallelogram that is slanted toward a top;
processing a second page container with a shape of a parallelogram that is slanted toward a bottom; and
placing the first page container with the second page container alternatively to present page contents.

14. An apparatus for processing a page at a touch screen display, the method comprising:
a page dividing module that divides the page into multiple page sections, each page section including one or more page containers;
a gesture detecting module that detects a gesture that triggers a page processing; and
a page processing module that applies the page processing to a gesture affected area of the gesture, the gesture affected area including one or more page sections, the page processing including enlarging or reducing a size of a page container in the gesture affected area.

15. The apparatus as recited in claim 14, wherein:
when the gesture detecting module detects that the gesture is an expansion gesture that increases an effective distance between points at the touch screen display, the page processing module further enlarges the size of the page container along the enlarging direction in the gesture affected area; and
when the gesture detecting module detects that the gesture is a pinch gesture that decreases the effective distance between points at the touch screen display, the page processing module further reduces the size of the page container along the reducing direction in the gesture affected area.

17. The apparatus as recited in claim 14, wherein:
when the gesture detecting module detects that the gesture is an expansion gesture that increases an effective distance between points at the touch screen display, the page processing module further reduces a size of a page container along the enlarging direction in a gesture adversely affected area; and
when the gesture detecting module detects that the gesture is a pinch gesture that decreases an effective distance between points at the touch screen display, the page processing module further enlarges a size of a page container along the reducing direction in a gesture adversely affected area.

18. The method as recited in claim 14, further comprising:
when the page is displayed in an up and down mode, the page processing module further:
processes a first page container with a shape of a parallelogram that is slanted toward left;
processes a second page container with a shape of a parallelogram that is slanted toward right; and
places the first page container with the second page container alternatively to present page contents.

19. The apparatus as recited in claim 14, further comprising:
when the page is displayed in a left and right mode, the page processing module further:
processes a first page container with a shape of an inverted trapezoid that is wider at a left and narrower at a right;
processes a second page container with a shape of a trapezoid that is narrower at a left and wider at a right; and
places the first page container with the second page container alternatively to present page contents.

20. A device comprising:
a touch screen display;
one or more processor(s); and
one or more computer storage media having stored thereon computer-executable instructions that are executable by the one or more processor(s) to perform operations comprising:
dividing the page into multiple page sections, each page section including one or more page containers;
detecting a gesture that triggers a page processing; and
applying the page processing to a gesture affected area of the gesture, the gesture affected area including one or more page sections, the page processing including enlarging or reducing a size of a page container in the gesture affected area.
